(19) United States
(12) Patent Application Publication
(10) Pub. No.: US 2024/0346691 A1
(43) Pub. Date: Oct. 17, 2024

(54) METHOD FOR GENERATING AN ENVIRONMENT REPRESENTATION

(71) Applicants: ROBERT BOSCH GmbH, Stuttgart (DE); CARIAD SE, Wolfsburg (DE)

(72) Inventor: Denis Tananaev, Sindelfingen (DE)

(21) Appl. No.: 18/636,920

(22) Filed: Apr. 16, 2024

(30) Foreign Application Priority Data
Apr. 17, 2023 (DE) 102023109651.6

(51) Int. Cl. G06T 7/73; G06T 17/00; G06V 10/766; G06V 10/82; G06V 20/58

(52) U.S. Cl. CPC G06T 7/75; G06T 17/00; G06V 10/766; G06V 10/82; G06V 20/58; G06T 2207/20016; G06T 2207/20021; G06T 2207/20081; G06T 2207/20084; G06T 2207/30252

(57) ABSTRACT

The invention relates to a method (100) for generating an environment representation (90), comprising the following steps:
providing (101) at least one image (40) which results from a recording by at least one image-capturing device (25) and shows at least one object (60) and/or a navigable region (65) in an environment of the at least one image-capturing device (25), the image (40) being split into a plurality of image columns (41),
generating (102) the environment representation (90), one stixel and/or free space element (30) of the respective image column (41) of the at least one provided image (40) being parameterized for this purpose in order to represent the object (60) and/or the navigable region (65).

This application claims the benefit of German application DE 10 2023 109 651.6 (filed on Apr. 17 2023), the entirety of which is incorporated by reference herein.

The invention relates to a method for generating an environment representation. The invention further relates to a machine learning model, to a computer program, to a device, and to a storage medium for this purpose.

### PRIOR ART

The detection of stixels and free spaces is an important task in robotics and in self-propelled or autonomous systems, since they make it possible to represent the regions in which the autonomous agent can move. Likewise, regions can be represented thereby which are dangerous to collision objects and accordingly need to be avoided for safe navigation.

The most recent progress in the field of deep neural networks has made it possible to significantly increase the performance and robustness of algorithms for detecting stixels and free spaces. Examples of solutions that are based on deep learning are set out in the following articles: “Levi et al., StixelNet: A Deep Convolutional Network for Obstacle Detection and Road Segmentation, In: BMVC 2015, Pages 109.1-109.12” and “Verner et al., Real-time category-based and general obstacle detection for autonomous driving, In: ICCV 2017”.

Although stixels and free space detection can provide good results in the systems set out, they often do not work with images having different resolutions. This limitation can be critical when the stixel/free space detection algorithm is intended to be provided for different cameras having different resolutions.

### DISCLOSURE OF THE INVENTION

The invention relates to a method having the features of claim 1, to a machine learning model having the features of claim 7, to a computer program having the features of claim 8, to a device having the features of claim 9, and to a computer-readable storage medium having the features of claim 10. Further features and details of the invention will become clear from the respective dependent claims, the description, and the drawings. In this case, features and details which are described in conjunction with the method according to the invention are of course also applicable in conjunction with the machine learning model according to the invention, the computer program according to the invention, the device according to the invention, and the computer-readable storage medium according to the invention, and vice versa, and therefore mutual reference is always made or can be made to the individual aspects of the invention with regard to the disclosure.

The invention relates in particular to a method for generating an environment representation, comprising the following steps, which can preferably be performed in succession and/or repeatedly and/or in an automated manner:
providing at least one image which results from a recording by at least one image-capturing device and shows at least one object and/or a navigable region in an environment of the at least one image-capturing device, the image being designed to be split into a plurality of image columns,
generating the environment representation, (in particular exactly) one stixel and/or free space element of the respective image column of the at least one provided image being parameterized for this purpose in order to represent the object and/or the navigable region.

The navigable region can also be referred to as the free space. Furthermore, exactly one or a plurality of the at least one image can be provided and exactly one or a plurality of different ones of the at least one image-capturing device can be provided, which provide the image in a different resolution where necessary. Accordingly, the images can also show different objects and/or navigable regions, preferably with a different resolution. It is also possible for the method to be used in a single system or different systems, such as robots and/or vehicles, which comprise the different image-capturing devices.

In the context of the invention, it is possible that the environment representation is generated at least in part based on an output of a model which can be adapted, in particular without modifying the model and/or without retraining the model, to process the at least one provided image in different resolutions, in particular at a different height of the image columns, as an input. In other words, the model can be configured such that (in particular without modifying the model and/or without retraining the model) it can process different resolutions of images, and therefore the model can also be used for processing images from different image-capturing devices having different resolutions. For example, this is possible when the model not only predicts a single stixel and/or free space element, but also a plurality of possible stixel and/or free space element parameters, such as a plurality of positions for selection per image column. Preferably, the model is configured as a machine learning model in this case. For example, it can be provided that a stixel free space CNN decoder architecture is used, which allows for multiresolution inference. Furthermore, robust stixel free space parameterization based on the ordinal regression can be used. Therefore, the method according to the invention has the advantage that a solution, which is in particular based on machine learning and is preferably CNN-based, can be provided for multiresolution stixel and/or free space detection. This makes it possible to apply stixels and free spaces to images having different resolutions.

The expression “stixel and/or free space element” can in particular relate to a stixel and/or to an element for free space representation. The output of the model can e.g. include at least one parameter for the respective stixel and/or free space for representation of an object and/or the free space. The at least one parameter includes a position in the image column, for example. The stixel elements can each be configured as stixels and can represent the height of the lowermost point to the uppermost point of the next obstacle and can be accordingly parameterized for this purpose. The stixels can optionally also be allocated a class label and the distance from this obstacle.

The at least one image can e.g. be provided, preferably ascertained, in that the at least one image is processed as a digital input. Accordingly, the at least one image can be configured as at least one digital image and can thus include digital data. In this case, the image can e.g. have been obtained via an interface from an electronic image sensor of the image-capturing device, in particular by means of analog-to-digital conversion. This means that the at least one provided image can result from a recording by an image-capturing device. In this case, the method steps and preferably the provision of the at least one image can be performed by an electronic data-processing device and/or by a computer program, optionally at least partially also within an image-capturing device, such as a camera itself.

The respective stixel element is configured as a stixel, preferably as a “single stixel” (by contrast with “multi-stixels”), for example. Each stixel can represent at least part of an object and/or a surface in the environment, in particular an ego vehicle and/or a robot. In the context of the invention, a stixel can also be referred to as a depth representation. In particular in computer vision, a stixel is understood to be a superpixel representation of depth information in an image in the form of a vertical stick (also called a strip). This representation makes it possible to approximate the closest obstacles within a certain vertical section of the scene (cf. Badino, Hernán; Franke, Uwe; Pfeiffer, David (2009). The stixel world—A compact medium level representation of the 3D-world. Joint Pattern Recognition Symposium). In this case, stixels can also be provided in the form of narrow vertical rectangles which represent a segment of a vertical surface which belongs to the closest objects in the observed scene, i.e. in the environment. They make it possible to drastically reduce the amount of information required to represent a scene in the event of such problems. In this case, a stixel can be characterized by a plurality of parameters, such as a vertical coordinate (position) and/or the height of the strip and/or the depth. Here, the different depths result e.g. from a distance of the object or the surface in the environment starting from the vehicle comprising the image-capturing device, i.e. the ego vehicle or the robot.

In addition, it is advantageous if, based on an at least partially automated evaluation of the generated environment representation, an at least partially autonomous robot, in particular a vehicle, is controlled, preferably in an at least partially automated manner and preferably autonomously, the image-capturing device preferably being designed as a camera of the robot. It is also possible for the robot to comprise a plurality of image-capturing devices, which are configured to provide the images in a differing resolution. Specifically, it can be provided that, based on an automated evaluation of the environment representation, a vehicle is controlled in an automated manner and preferably autonomously, with the (respective) image-capturing device being mounted on the vehicle in the form of a camera. It is possible for the vehicle to be designed as a motor vehicle and/or a passenger car and/or a self-driving vehicle. The vehicle can comprise a vehicle apparatus, for example for providing an autonomous driving function and/or a driver assistance system. The vehicle apparatus can be configured to at least partially automatically control and/or accelerate and/or brake and/or steer the vehicle.

Furthermore, it is conceivable for the model to be configured as a machine learning model, and to preferably comprise at least one or exactly one artificial neural network, preferably in the form of a CNN, particularly preferably a fully convolutional CNN. In this case, a CNN is also referred to as a convolutional neural network. Here, the output of the model, preferably in the form of an output tensor, can indicate a plurality of possible and preferably alternative positions for the stixel and/or free space element in the respective image column. The stixel and/or free space element can then be parameterized based on the indicated possible positions, preferably by one, in particular exactly one, position for the stixel and/or free space element being selected from the plurality of possible (alternative) positions per image column. This can be carried out by means of an ordinal regression, for example. In this case, the stixel and/or free space element can preferably only be parameterized with the selected position. This makes it possible for the model to be trained to output a plurality of possible pixel positions for the height, with a single stixel and/or free space element, in particular a single stixel and not a multi-stixel, then being able to be selected and used. The ordinal regression can use a voting mechanism here for selecting the possible positions.

In another option, it can be provided that the respective stixel and/or free space element is parameterized in that the respective stixel and/or free space element is defined at least by a lowermost point, to which depth information on a distance of the object represented by the stixel and/or free space element is preferably assigned. In this case, an ordinal regression can be performed for the parameterization of the respective stixel and/or free space element, preferably in order to determine the lowermost point of the stixel and/or free space element. The position of the lower and optionally also the upper point can thus be determined in pixel coordinates for each column of the image. Furthermore, the class designation and depth information, such as a distance from the object, can optionally also be determined by the model for each image column.

Preferably, it can be provided that the model is adapted to process the at least one provided image in the different resolutions as an input in that a height of the image columns is substantially maintained by the model when processing the provided image. Conventional solutions, however, always reduce the height to 1 pixel by what is known as “clumping” and directly output a single stixel. It can also be provided that the model is adapted to process the at least one provided image in the different resolutions as an input in that a plurality of possible and optionally alternative positions of the stixel and/or free space element are ascertained in the respective image column and are made available for selection in the output. In this case, a number of possible positions that are ascertained and/or output by the model can be dependent on the resolution of the provided image. This is related to the fact that, at a higher resolution, a greater number of possible positions in the image column also come into question. Preferably, the different resolutions differ in terms of the height of the image columns, the model particularly preferably being adapted to process images in at least 10, at least 100, or at least 1000 different resolutions.

Furthermore, it is possible for the model to be configured as a machine learning model, which, in a or the trained state, is also configured to output a prediction of the stixel and/or free space element of the respective image column at different resolutions of the input during an application. In this case, the trained state can result from a training of the machine learning model, in which training data for the training comprise a plurality of images in a resolution that differs from the resolutions of the input during the application. In other words, the model can have been trained at a resolution that is different from that which is used in the subsequent application without the model needing to be retrained.

The invention also relates to a machine learning model which is configured to process an image split into a plurality of image columns in different resolutions as an input in order to predict a plurality of possible positions per image column for a respective stixel and/or free space element of the image columns. In this case, the image can result from a recording by at least one image-capturing device and show at least one object and/or a navigable region in an environment of the at least one image-capturing device. Likewise, the respective stixel and/or free space element can be configured to represent the object and/or the navigable region. Therefore, the machine learning model according to the invention has the same advantages as have been described in detail with reference to a method according to the invention. Conventional solutions are often not capable of working with a camera resolution that differs from that at the time of the training. The method according to the invention can provide the advantage that the machine learning model is trained with a fixed resolution, but after the training can be applied to image-capturing devices such as cameras having different resolutions without needing to be retrained. As a result, the effort required for labeling the training data, for example, can be reduced, since the data set can be used with the fixed resolution for the training for a plurality of different image-capturing device or camera resolutions. In addition, generalizability of a single machine learning model, in particular CNN, is possible by means of different cameras having a different resolution. Therefore, it is not necessary to train separate machine learning models for each new camera.

The invention also relates to a computer program, in particular a computer program product, comprising commands which, when the computer program is executed by a computer, cause said computer to carry out the method according to the invention. Therefore, the computer program according to the invention has the same advantages as have been described in detail with reference to a method according to the invention.

The invention also relates to a data processing device configured to carry out the method according to the invention. By way of example, a computer that executes the computer program according to the invention may be provided as the device. The computer can comprise at least one processor for executing the computer program. A non-volatile data memory can also be provided in which the computer program is stored and from which the computer program can be read out by the processor for execution.

The invention also relates to a computer-readable storage medium comprising the computer program according to the invention and/or commands which, when executed by a computer, cause said computer to carry out the method according to the invention. By way of example, the storage medium is designed as a data memory such as a hard drive and/or a non-volatile memory and/or a memory card. The storage medium may e.g. be integrated in the computer. The storage medium can likewise comprise the machine learning model according to the invention.

Furthermore, the method according to the invention can also be configured as a computer-implemented method.

Further advantages, features, and details of the invention become apparent from the following description, in which exemplary embodiments of the invention are described in detail with reference to the drawings. Here, the features mentioned in the claims and the description can all be essential to the invention in isolation or in any combination. In the drawings:

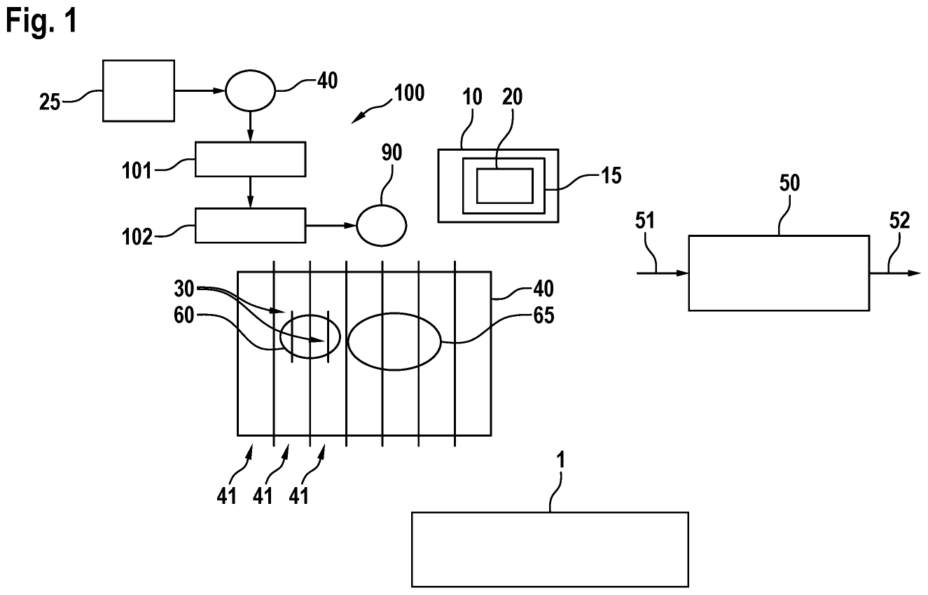

FIG. 1 is a schematic representation of a method, a device, a machine learning model, a storage medium, and a computer program according to exemplary embodiments of the invention.

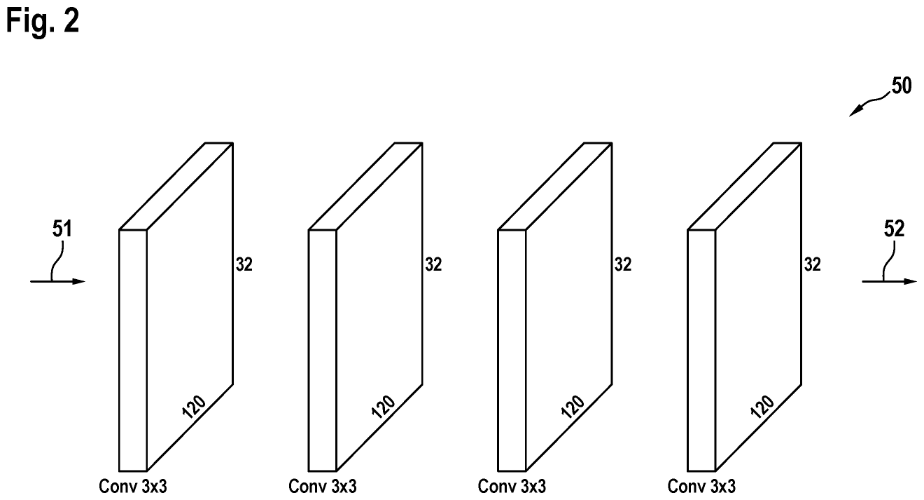

FIG. 2 shows an exemplary CNN head architecture for the CNN according to exemplary embodiments of the invention without clumping of the height dimension.

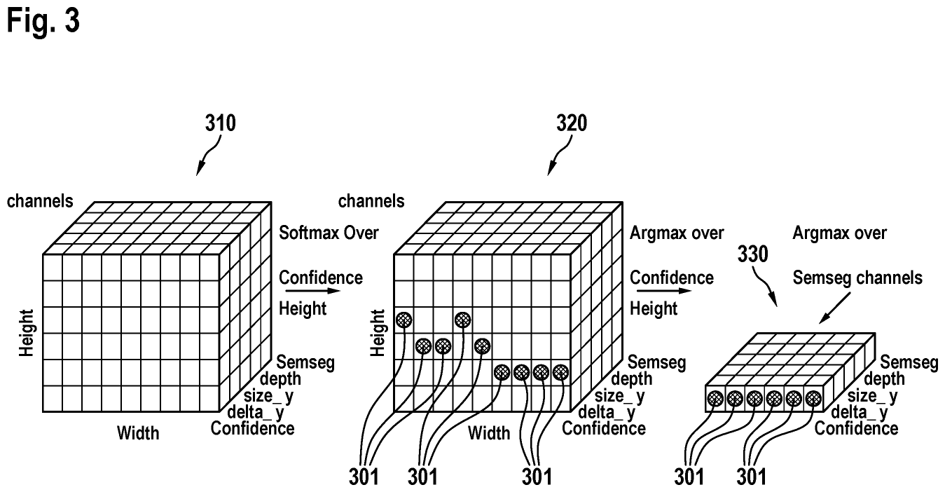

FIG. 3 is a schematic representation of the post-processing of the output tensor in order to obtain stixels.

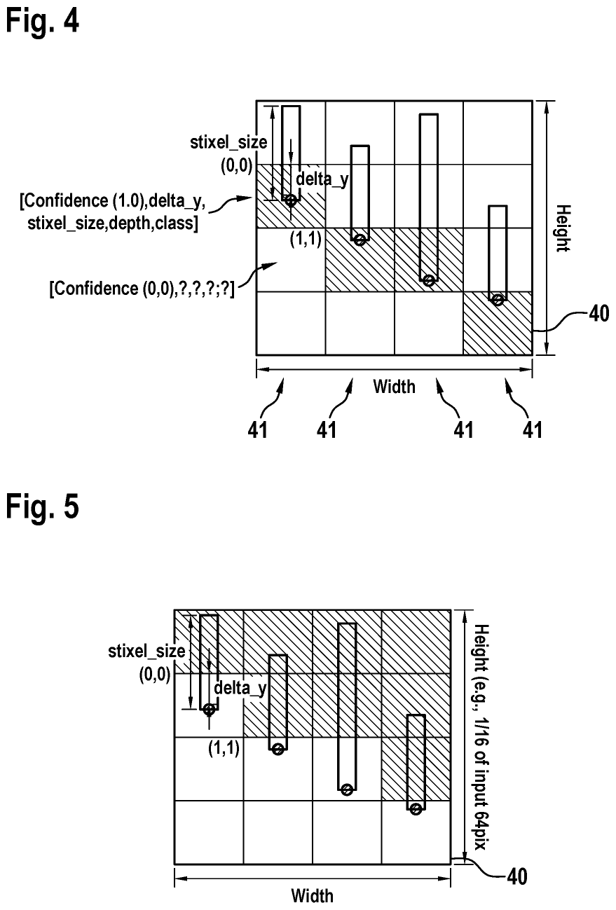

FIG. 4 is a schematic representation of the parameterization of the stixels with confidence.

FIG. 5 is a schematic representation of the parameterization of the stixels with ordinal regression.

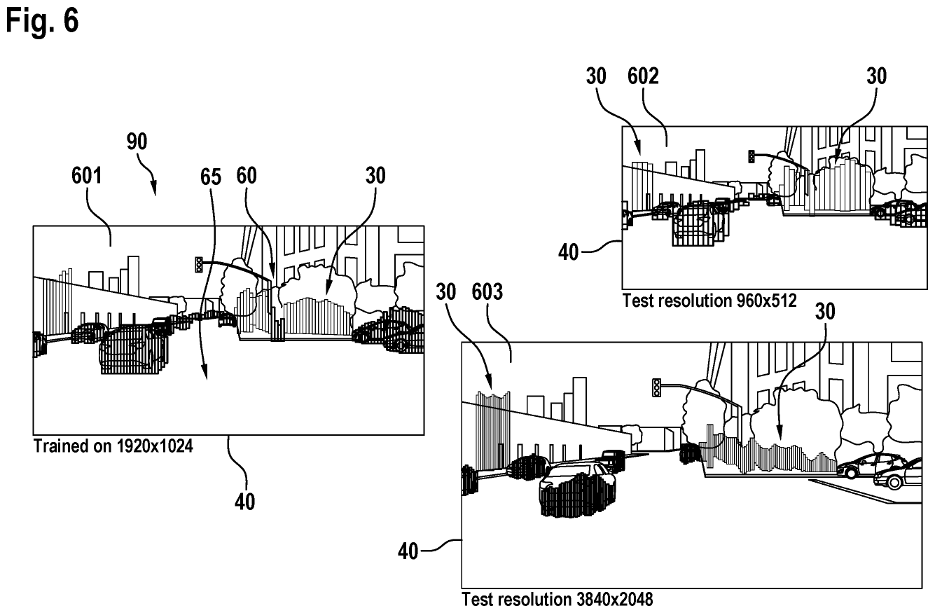

FIG. 6 shows an exemplary result of the multiresolution inference.

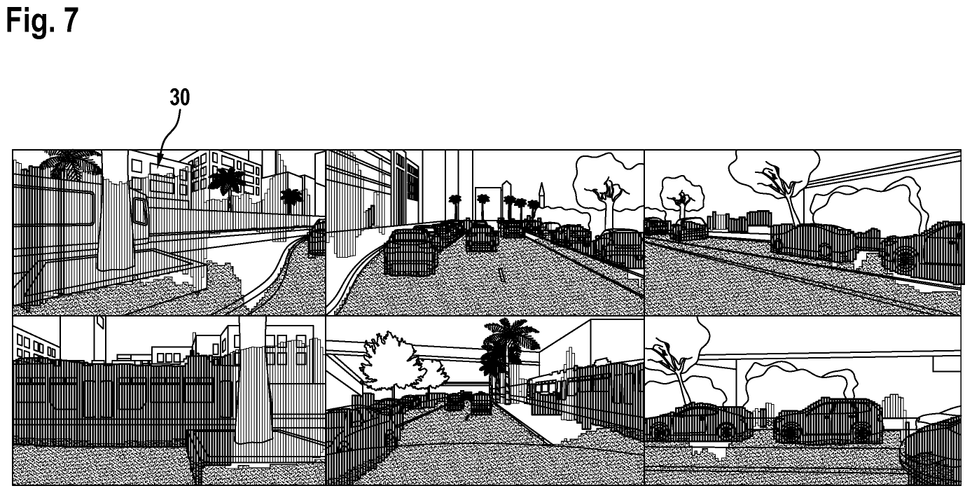

FIG. 7 shows an exemplary multi-camera output for 3D stixels.

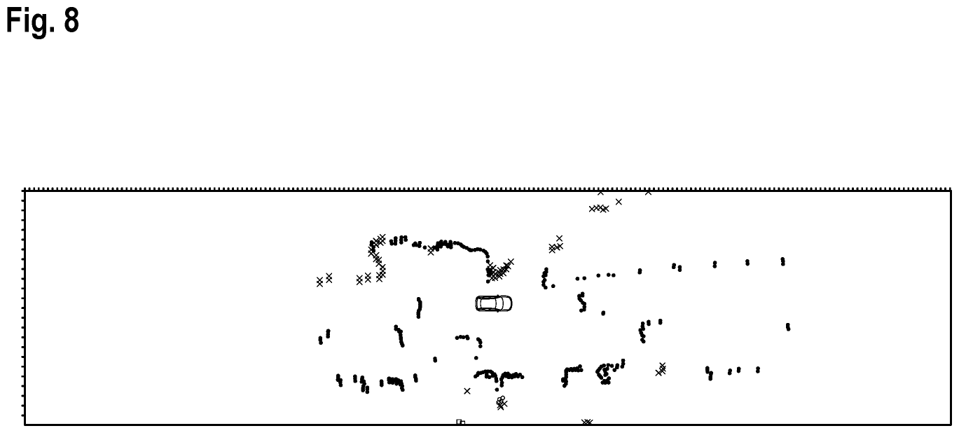

FIG. 8 is a plan view of the environment for the exemplary multi-camera output for 3D stixels.

FIG. 1 schematically shows a method 100, a device 10, a storage medium 15, a machine learning model 50, and a computer program 20 according to exemplary embodiments of the invention. Here, the method 100 is used to generate an environment representation 90. According to a first method step 101, at least one image 40 is provided which results from a recording by an image-capturing device 25 and shows at least one object 60 and/or a navigable region 65 in an environment of the image-capturing device 25. Here, it is schematically shown that the image 40 can be split into a plurality of image columns 41. According to a second method step 102, the environment representation 90 can be generated, one stixel and/or free space element 30 of the respective image column 41 of the at least one provided image 40 being parameterized for this purpose in order to represent the object 60 and/or the navigable region 65. The environment representation 90 can e.g. be generated in the form of digital data and can be evaluated for controlling a robot. In this case, the environment representation 90 can be generated 102 at least in part based on an output 52 of a model 50 which is adapted to process the at least one provided image 40 in different resolutions as an input 51. Furthermore, based on an at least partially automated evaluation of the generated environment representation 90, an at least partially autonomous robot 1, in particular a vehicle 1, as shown in FIG. 1, can be controlled.

Exemplary embodiments of the invention can make it possible to detect generic objects 60 and free spaces, which is particularly important for at least partially autonomous robots 1 or navigation systems for self-propelled vehicles 1 comprising high-resolution cameras, for example. In an at least partially autonomous robot 1, in particular a self-propelled or autonomous vehicle 1, it is for example provided that obstacles are detected and their semantic class is identified. Stixels and free spaces are simple but robust representations of the navigable space and generic objects 60, in particular obstacles. Stixels are used in particular for object representation and can make it possible to perceive an environment in real time. In this case, an image 40 can be split into a plurality of vertical columns, and individual pixels or each pixel of the image 40 can be assigned to such a column. Stixels can then represent the height of the environment along each column. The region in the image 40 that is free of objects and can thus be navigated by the at least partially autonomous robot 1 can be referred to as the free space.

Conventional CNN-based solutions cannot be generalized for different camera resolutions, and this makes the scaling to many different products or cameras very complex. By contrast, exemplary embodiments of the invention make it possible to train a single CNN which can be effectively generalized to different cameras having different resolutions, in particular without complex manual labeling and retraining being required. As a result, very simple maintenance of the functionality can be made possible for many different products having different camera configurations.

FIG. 2 also shows the model 50 by way of example, which can be configured as a fully convolutional CNN. In this case, the output 52 of the model 50 can comprise an output tensor 310, which is shown in FIG. 3 with further details. The output 310 can indicate a plurality of possible positions for the stixel and/or free space element 30 in the respective image column 41.

The features described in the following relate to both stixel elements and free space elements 30, even if sometimes either just stixels or free spaces are described by way of example.

In a first step, the fully convolutional CNN can be trained in the following manner. First, it can be provided that the fully convolutional CNN shown in FIG. 2 is used as a machine learning model 50. By contrast with traditional CNNs, which have fully connected layers at the end, the fully convolutional CNN can exclusively comprise convolutional layers and pooling layers.

It can be seen in FIG. 2 that the resolution and/or the height of the images 40 is not modified by the model 50 during the processing, by contrast with the otherwise standard clumping of the dimensions of the output tensor 310. In this case, the “clumping” of the dimensions of the output tensor 310 can relate to a process in which the output tensor 310 is transferred into another dimension. In conventional solutions, this process is used to obtain a single stixel/free space per image column as an output of the model. By contrast, in the model 50 according to configuration variants of the invention, the clumping can be dispensed with and, instead, a plurality of possible parameters for the stixel/free space per image column 41 are obtained. Accordingly, in the output 52, the final parameterization of the respective stixel/free space is not yet fixed. For selecting and specifying the parameters, post-processing of the output 52 can be provided, preferably by an ordinal regression. In this way, an ordinal loss can be applied to the first two dimensions of the output tensor 310. A loss for other stixel/free space parameters can then be applied only at the points of the tensor at which a correct ground truth is available. This is represented in FIG. 3 with further details; see the middle tensor 320, in which the loss is only applied to the channels having the circles 301.

In a second step, it can be provided that, in the inference time for the resulting output tensor 310, the argmax operation is applied to the first two dimensions and then the total is obtained across the vertical columns (in FIG. 3, the results are the indices of the circles 301). Two calculated index values can then be used to collect the vectors from the channel dimensions and obtain the final stixel representation.

In exemplary embodiments of the invention, a fully convolutional CNN can be used and trained, with clumping of the height dimension being dispensed with. First, a three-dimensional grid can be used as the coordinate grid in order to locate the positions of the stixels at a local level (see FIG. 4). There are in particular two possible parameterizations for the position of the stixels/free spaces in the three-dimensional tensor: by using a confidence map as shown in FIG. 4, or by ordinal regression (FIG. 5). In the case of parameterization of the stixels using the confidence map, the CNN output is a tensor in the form [(confidence, delta_y, stixel_size, depth, num_of_classes), height, width] or [4+num_classes, output_height, output_width]. A confidence map can be a representation that indicates how reliable the results of the model are.

During the training, the following loss functions can be applied:

$${L}_{conf} = binary\_cross \_entropy ( {C}_{gt} , {C}_{pd} ) \qquad ( 1 )$$

Here, C_{gt} is the confidence tensor for the ground truth, where 1.0 is the confidence for the correct lower position of the stixel (or the end position of the free space) and otherwise is 0.0. C_{pd} is the confidence tensor predicted by the CNN. For example, the confidence can be interpreted as the probability that the prediction of the model 50 is correct.

$${L}_{delta \_ y} = ‖ {delta\_y}_{gt} - {delta\_y}_{pd} ‖ * {C}_{gt} \qquad ( 2 )$$

Here, delta_y_{gt} is the ground truth and delta_y_{pd} is the CNN prediction of the position of the lower point of the stixel and/or the end point of the free space.

$${L}_{stixel \_ size} = ‖ {stixel\_size}_{gt} - {stixel\_size}_{pd} ‖ * {C}_{gt} \qquad ( 3 )$$

Here, stixel_size_{gt} is the ground truth and stixel_size_{pd} is the CNN prediction of the stixel size.

$${L}_{disparity} = {‖ {disparity}_{gt} - {disparity}_{pd} ‖}_{1} * {C}_{gt} \qquad ( 4 )$$

Here, disparity_{gt} is the ground truth and disparity_{pd} is the CNN prediction of the disparity. The stixel disparity can e.g. be used to calculate the distance of objects in the scene.

$${L}_{classes} = categorical\_cross \_entropy ( {class}_{gt} , {class}_{pd} ) \qquad ( 5 )$$

Here, class_{gt} is the ground truth and class_{pd} is the CNN prediction of the class designations.

In the case of ordinal regression parameterization (FIG. 5), binary cross entropy can be used as for the confidence. Likewise, categorical cross entropy can be used for the classification into two categories. The total loss can then be calculated as follows:

$$L = w 1 * {L}_{classes} + w 2 * {L}_{conf} + w 3 * {L}_{{delta}_{y}} + w 4 * {L}_{{stixel}_{size}} + w 5 * {L}_{disparity} \qquad ( 6 )$$

Here, w1, w2, w3, w4, w5 are the weights for regulating the influence of the individual loss components.

At the time of the inference with a given output tensor 310 of the CNN, the indices of the correct stixel/free space position can first be calculated within the greed (see FIG. 3, in particular the circles 301 in the middle tensor 320). In the case of the confidence tensor, this can be carried out as follows:

$${position}_{idx} = arg {max}_{h} ( {softmax}_{c} ( confidence\_tensor ) ) \qquad ( 7 )$$

where argmaxₕ is the argmax operation over the height dimension and softmax_{c} is the softmax operation over the channel dimension of the confidence tensor. In this case, inference can relate to a process of using the machine learning model to make predictions on new, unprocessed data outside the training data set. This means that this model is applied to a new input in order to generate an output.

In the case of an ordinal regression which is represented by categorical cross entropy,

$${position}_{idx} = {\sum }_{h = 0}^{H} arg {max}_{c} ( confidence\_tensor ) \qquad ( 8 )$$

can be calculated. Here, argmax, is the argmax operation over the channel dimension and H is the height dimension of the tensor.

From position_{idx}, the correct stixels, disparity, delta_{y}, stixel_size, and class designation can be ascertained (see FIG. 3, tensor 330). In order to obtain the coordinates of the lower point in pixels, the following calculation can be carried out:

$${y}_{bottom} = ( {position}_{idx} + {delta}_{y} ) * scale \qquad ( 9 )$$

Here, scale=image_height/cnn_output_height. In order to obtain the coordinate of the upper point in pixels, the following calculation can be used:

$${y}_{top} = {y}_{bottom} - stixel\_size * scale \qquad ( 10 )$$

And to calculate the depth:

$$depth = \frac{1.}{\frac{disparity}{{depth}_{min}} + \frac{1.}{{depth}_{max}}} \qquad ( 11 )$$

Here, depthₘᵢₙ and depthₘₐₓ are scalar values for the expected minimum and maximum depth range in meters.

To obtain the Semseg class, the following calculation can be carried out

$$class = arg {max}_{c} ( {softmax}_{c} ( label\_tensor ) ) \qquad ( 12 )$$

Here, argmax, and softmax, are argmax and softmax operations over channel dimensions. Furthermore, for the free space prediction, only y_bottom and the class designation of the contacted object/space can be output.

Exemplary results of the approach of exemplary embodiments of the invention are shown in FIG. 6 and FIG. 7. In this case, a first resulting multiresolution inference 601 is based on training with 1920×1024 pixels. A second resulting multiresolution inference 602 is based on training with 960×512 pixels. A third resulting multiresolution inference 603 is based on training with 3840×2048 pixels. FIG. 8 further shows an environment representation in a view from above of the results in FIG. 7.

An exemplary training of the model 50 can be carried out as follows. Images 40 can first be provided which show objects 60 and/or surfaces in an environment. Annotation data can also be used which indicate the correct stixel parameters for these images 40. The images 40 can be provided in a resolution provided for the training. The training of the model 50 can then be carried out, in which the provided image 40 is used as an input 51 for the model 50 in order to train the model 50 based on the annotation data for an output 52 of a plurality of possible positions of one stixel per image column 41 of the provided image 40. It is also conceivable that, for the parameterization of the respective stixel, an ordinal regression is used, preferably to determine a lowermost and/or an uppermost point of the stixel in the image column 41. The ordinal loss can be applied for each stixel in order to obtain the lowermost point of the stixel. The model 50 can also be configured as an end-to-end machine learning model 50, preferably as a neural network, preferably as a convolutional neural network.

The above explanation of the embodiments describes the present invention only in the context of examples. It goes without saying that, where technically feasible, individual features of the embodiments can be freely combined with one another without departing from the scope of the present invention.

1. A method for generating an environment representation, comprising the following steps:
providing at least one image which results from a recording by at least one image-capturing device and shows at least one object and/or a navigable region in an environment of the at least one image-capturing device, the image being split into a plurality of image columns,
generating the environment representation, one stixel and/or free space element of the respective image column of the at least one provided image being parameterized for this purpose in order to represent the object and/or the navigable region,
characterized in that the environment representation is generated at least in part based on an output of a model which is adapted to process the at least one provided image in different resolutions as an input.

2. The method according to claim 1,
characterized in that the model is configured as a machine learning model, and preferably comprises at least one or exactly one artificial neural network, preferably in the form of a CNN, particularly preferably a fully convolutional CNN, the output of the model, preferably in the form of an output tensor, indicating a plurality of possible positions for the stixel and/or free space element in the respective image column, the stixel and/or free space elements being parameterized based on the indicated possible positions, preferably by one, in particular exactly one, position for the stixel and/or free space element being selected from the plurality of possible positions per image column, preferably by means of an ordinal regression, the stixel and/or free space element preferably only being parameterized with the selected position.

3. The method according to claim 1, characterized in that the respective stixel and/or free space element is parameterized in that the respective stixel and/or free space element is defined at least by a lowermost point, to which depth information on a distance of the object represented by the stixel and/or free space element is preferably assigned, an ordinal regression being performed for the parameterization of the respective stixel and/or free space element, preferably in order to determine the lowermost point of the stixel and/or free space element.

4. The method according to claim 1, characterized in that the model is adapted to process the at least one provided image in the different resolutions as an input in that a height of the image columns is substantially maintained by the model when processing the provided image and/or a plurality of possible positions of the stixel and/or free space element are ascertained in the respective image column and are made available for selection in the output, a number of possible positions that are ascertained and/or output by the model preferably being dependent on the resolution of the provided image, the different resolutions preferably differing with respect to the height of the image columns, the model particularly preferably being adapted to process images in at least 10, at least 100, or at least 1000 different resolutions.

5. The method according to claim 1, characterized in that the model is configured as a machine learning model, which, in the trained state, is also configured to output a prediction of the stixel and/or free space element of the respective image column at different resolutions of the input during an application, the trained state resulting from a training of the machine learning model, in which training data for the training comprise a plurality of images in a resolution that differs from the resolutions of the input during the application.

6. The method according to claim 1, characterized in that based on an at least partially automated evaluation of the generated environment representation, an at least partially autonomous robot, in particular a vehicle, is controlled, preferably in an at least partially automated manner and preferably autonomously, the at least one image-capturing device preferably being designed as a camera of the robot and/or the robot preferably comprising a plurality of image-capturing devices which are configured to provide the images in a differing resolution.

7. A machine learning model which is configured to process an image split into a plurality of image columns in different resolutions as an input in order to predict a plurality of possible positions per image column for a respective stixel and/or free space element of the image columns, the image resulting from a recording by at least one image-capturing device and showing at least one object and/or a navigable region in an environment of the at least one image-capturing device, and the respective stixel and/or free space element being configured to represent the object and/or the navigable region.

8. (canceled)

9. A data processing device configured to
a processor;
a memory communicatively coupled to the processor and storing a computer program, that when executed by the processor, causes the processor to:
provide at least one image which results from a recording by at least one image-capturing device and shows at least one object and/or a navigable region in an environment of the at least one image-capturing device, the image being split into a plurality of image columns,
generate the environment representation, one stixel and/or free space element of the respective image column of the at least one provided image being parameterized for this purpose in order to represent the object and/or the navigable region,
characterized in that the environment representation is generated at least in part based on an output of a model which is adapted to process the at least one provided image in different resolutions as an input.

10. A computer-readable storage medium comprising commands which, when executed by a computer, cause said computer to;
provide at least one image which results from a recording by at least one image-capturing device and shows at least one object and/or a navigable region in an environment of the at least one image-capturing device, the image being split into a plurality of image columns,
generate the environment representation, one stixel and/or free space element of the respective image column of the at least one provided image being parameterized for this purpose in order to represent the object and/or the navigable region,
characterized in that the environment representation is generated at least in part based on an output of a model which is adapted to process the at least one provided image in different resolutions as an input.
